(19) United States
(12) Patent Application Publication
(10) Pub. No.: US 2024/0214862 A1
(43) Pub. Date: Jun. 27, 2024

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC Corporation, Tokyo (JP)

(21) Appl. No.: 18/288,940

(22) PCT Filed: May 10, 2021
(86) PCT No.: PCT/CN2021/092838

§ 371 Date: Oct. 30, 2023

(51) Int. Cl. H04W 28/02; H04W 76/27; H04W 76/38

(52) U.S. Cl. CPC H04W 28/0252; H04W 76/27; H04W 76/38

(57) ABSTRACT

Embodiments of the present disclosure relate to methods, devices and computer readable media for communication. A terminal device determines whether a radio link control, RLC, entity re-establishment for a radio bearer is to be performed, the radio bearer being configured with a transmission of data in an inactive state. If it is determined that the RLC entity re-establishment is to be performed, the terminal device re-establishes the RLC entity. After that, the terminal device transmits uplink data in the inactive state on the radio bearer. In this way, an RLC entity re-establishment is able to be handled for radio bearer configured with SDT if the terminal device determines that the RLC entity re-establishment needs to be performed for the SDT, thereby improving performance of the SDT procedure.

### CROSS REFERENCE TO RELATED APPLICATIONS

This application is a National Stage of International Application No. PCT/CN2021/092838 filed May 10, 2021.

### TECHNICAL FIELD

Embodiments of the present disclosure generally relate to the field of telecommunication, and in particular, to methods, devices and computer storage media of communication during data transmission in an inactive state of a terminal device.

### BACKGROUND

Typically, a terminal device in an inactive state may still have small and infrequent data traffic to be transmitted. Until the third generation partnership project (3GPP) Release 16, the inactive state cannot support data transmission, and the terminal device has to resume connection (i.e., enter a connected state) for any downlink and uplink data. This will result in unnecessary power consumption and signaling overhead.

In this event, 3GPP Release 17 has approved small data transmission (SDT) in the inactive state. Thereby, the signaling overhead can be reduced. However, up to now, SDT-related techniques are still incomplete and to be further developed.

### SUMMARY

In general, embodiments of the present disclosure provide methods, devices and computer storage media for communication.

In a first aspect, there is provided a method of communication. The method comprises: determining, at a terminal device, whether a radio link control, RLC, entity re-establishment for a radio bearer is to be performed, the radio bearer being configured with a transmission of data in an inactive state; in accordance with a determination that the RLC entity re-establishment is to be performed, re-establishing the RLC entity; and transmitting, to a network device, uplink data in the inactive state on the radio bearer.

In a second aspect, there is provided a method of communication. The method comprises: in response to receiving uplink data and a radio resource control, RRC, resume request message from a terminal device in an inactive state, transmitting, to the terminal device, an RRC resume message comprising an indication for a radio link control, RLC, entity re-establishment for a radio bearer not configured with a transmission of data in an inactive state.

In a third aspect, there is provided a method of communication. The method comprises: determining, at a terminal device performing an transmission of uplink data in an inactive state, whether on-demand information is available; and in accordance with a determination that the on-demand information is unavailable, performing at least one of the following: triggering a transmission of a request for the on-demand information to a network device, or avoiding the transmission of the request for the on-demand information to the network device.

In a fourth aspect, there is provided a method of communication. The method comprises: aborting, at a terminal device, a transmission of uplink data in an inactive state in response to at least one of the following: receiving a paging message addressing the terminal device from a network device, receiving, at a radio resource control, RRC, layer of the terminal device an abortion of a connection establishment from a non-access stratum layer, an expiration of a first timer related to the transmission of the uplink data in the inactive state, a maximum number of radio link control, RLC, retransmissions has been reached, an initial uplink data transmission fails a predetermined number of times, and an indication being provided from a medium access control, MAC, layer of the terminal device to the RRC layer to cancel the transmission of the uplink data in the inactive state.

In a fifth aspect, there is provided a method of communication. The method comprises: determining, at a terminal device, a parameter of message authentication code-integrity, MAC-I, for a, radio resource control, RRC resume procedure based on a first value related to the RRC resume procedure; and transmitting an RRC resume request message comprising the parameter to initiate the RRC resume procedure, wherein the first value is different from a second value for determining the MAC-I of a further RRC resume procedure.

In a sixth aspect, there is provided a method of communication. The method comprises: triggering, at a terminal device, a power headroom report, PHR; in accordance with a determination that uplink data is to be transmitted in an inactive state, determining whether an uplink grant accommodates the uplink data and does not additionally accommodate the PHR; in accordance with a determination that the uplink grant accommodates the uplink data and does not additionally accommodate the PHR, allocating a resource to the uplink data; and transmitting, to a network device, the uplink data using the allocated resource.

In an seventh aspect, there is provided a terminal device. The terminal device comprises a processor and a memory coupled to the processor. The memory stores instructions that when executed by the processor, cause the terminal device to perform the method according to the first, third, fourth, fifth, sixth aspects of the present disclosure.

In an eighth aspect, there is provided a network device. The network device comprises a processor and a memory coupled to the processor. The memory stores instructions that when executed by the processor, cause the network device to perform the method according to the second aspect of the present disclosure.

In a ninth aspect, there is provided a computer readable medium having instructions stored thereon. The instructions, when executed on at least one processor, cause the at least one processor to perform the method according to the first, third, fourth, fifth, sixth aspects of the present disclosure.

In an tenth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented:

FIG. 1B illustrates a schematic diagram of a user plane (UP) protocol stack in which some embodiments of the present disclosure can be implemented:

FIG. 1C illustrates a schematic diagram of a control plane (CP) protocol stack in which some embodiments of the present disclosure can be implemented:

FIG. 2A illustrates a schematic diagram illustrating a SDT procedure in which some embodiments of the present disclosure can be implemented:

FIG. 2B illustrates a schematic diagram illustrating a SDT procedure comprising initial data transmission phase and a subsequent data transmission phase in which some embodiments of the present disclosure can be implemented:

FIG. 3 illustrates a signaling flow for a SDT procedure according to some embodiments of the present disclosure:

FIG. 4 illustrates a signaling flow for a SDT procedure according to some embodiments of the present disclosure:

FIG. 5 illustrates a signaling flow for a SDT procedure according to some embodiments of the present disclosure:

FIG. 6 illustrates a signaling flow for a SDT procedure according to some embodiments of the present disclosure:

FIG. 7 illustrates a signaling flow for a SDT procedure according to some embodiments of the present disclosure;

FIG. 8 illustrates an example method of communication implemented at a terminal device in accordance with some embodiments of the present disclosure:

FIG. 9 illustrates another example method of communication implemented at a network device in accordance with some embodiments of the present disclosure:

FIG. 10 illustrates another example method of communication implemented at a terminal device in accordance with some embodiments of the present disclosure:

FIG. 11 illustrates another example method of communication implemented at a terminal device in accordance with some embodiments of the present disclosure:

FIG. 12 illustrates another example method of communication implemented at a terminal device in accordance with some embodiments of the present disclosure:

FIG. 13 illustrates another example method of communication implemented at a terminal device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It should be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term “based on′ is to be read as ‘at least in part based on.’ The term ‘one embodiment’ and ‘an embodiment’ are to be read as “at least one embodiment.” The term “another embodiment” is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

### Example of Communication Environment

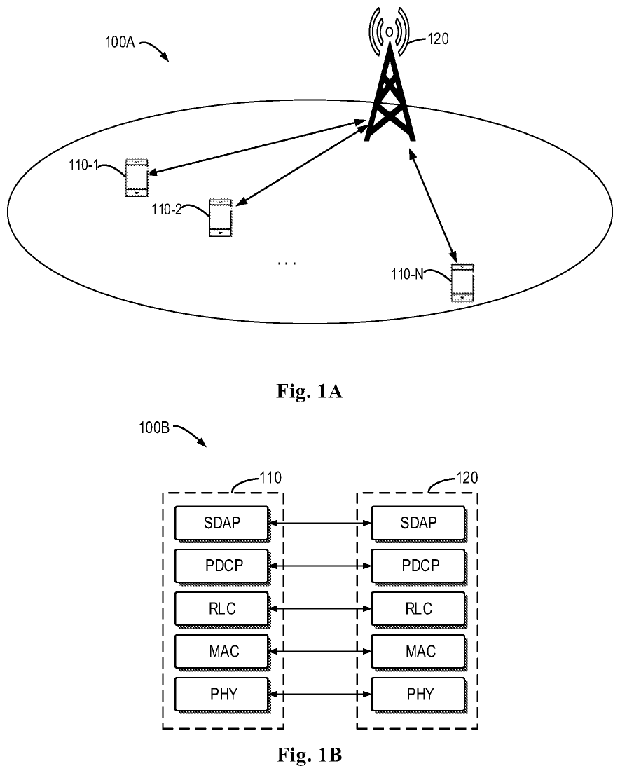

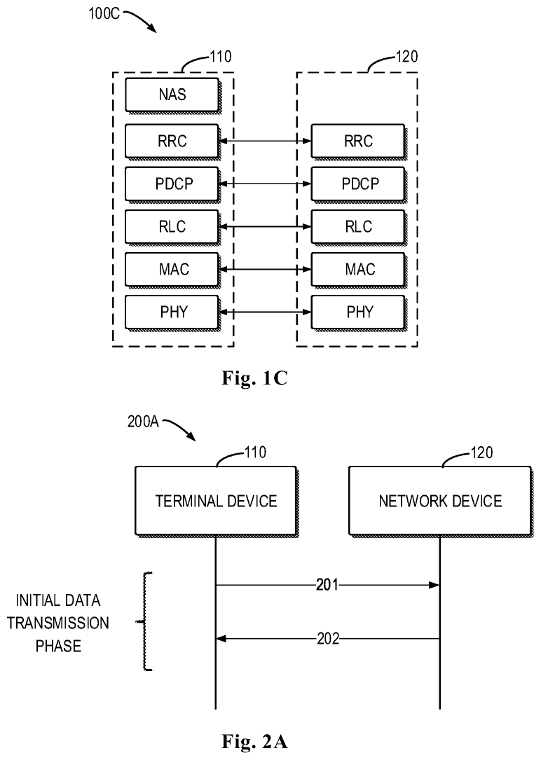

FIG. 1A illustrates an example communication system 100A in which some embodiments of the present disclosure can be implemented. The communication system 100A, which is a part of a communication network, includes a terminal device 110-1, a terminal device 110-2, . . . , a terminal device 110-N, which can be collectively referred to as “terminal device(s) 110.” The number N may be any suitable integer number.

The communication system 100A further includes a network device 120. In some embodiments, the network device 120 may be a gNB. Alternatively, the network device 120 may be IAB. Although not shown, there may also be more than one network device 120 in the communication system 100A.

In the communication system 100A, the network device 120 and the terminal devices 110 may communicate data and control information to each other. The numbers of terminal devices 110 and network device 120 shown in FIG. 1 are given for the purpose of illustration without suggesting any limitations.

As shown in FIG. 1A, the terminal device 110 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Communication in a direction from the terminal device 110 towards the network device 120 is referred to as UL communication, while communication in a reverse direction from the network device 120 towards the terminal device 110 is referred to as DL communication. The terminal device 110 can move amongst the cells of the network devices 120 and possibly other network devices. In UL communication, the terminal device 110 may transmit UL data (e.g., data transmitted using a data radio bearer (DRB) and/or data transmission using a signaling radio bearer (SRB)) to the network device 120 via a UL channel. In DL communication, the network device 120 may transmit DL data to the terminal device 110 via a DL channel.

The communications in the communication network 100A can be performed in accordance with UP and CP protocol stacks. Generally speaking, for a communication device (such as a terminal device 110 or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure.

As shown in FIG. 1B, in the UP, each of the terminal device 110 and the network device 120 may include an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may include an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as an RRC entity). The RRC layer may be also referred to as an access stratum (AS) layer, and thus the RRC entity may be also referred to as an AS entity. As shown in FIG. 1C, the terminal device 110 may also include an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may include a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may include a broadcast channel (BCH), a downlink shared channel (DL-SCH), a paging channel (PCH), an uplink shared channel (UL-SCH) and a random access channel (RACH).

The logical channels are channels between the MAC layer and the RLC layer. For example, the logical channels may include a dedicated control channel (DCCH), a common control channel (CCCH), a paging control channel (PCCH), broadcast control channel (BCCH) and dedicated traffic channel (DTCH).

Generally, channels between the RRC layer and PDCP layer or between SDAP layer and PDCP layer are called as radio bearers. The terminal device 110 may be configured with at least one DRB for bearing data plane data and at least one SRB for bearing control plane data. In the context of the present disclosure, a DRB may be configured as supporting a transmission in an inactive state (i.e., supporting SDT). Of course, a DRB may also be configured as not supporting a transmission in an inactive state. A SRB may be configured as supporting a transmission in an inactive state. Of course, a SRB may also be configured as not supporting a transmission in an inactive state.

Three types of SRBs are defined in an RRC layer, i.e., SRB0, SRB1 and SRB2. SRB0 uses a CCCH for RRC connection establishment or re-establishment. SRB1 uses a DCCH and is established when RRC connection is established. SRB2 uses a DCCH and is established during RRC reconfiguration and after initial security activation.

As mentioned above, 3GPP Release 17 has approved small data transmission (SDT) in the inactive state. There are various applications that involve exchange of small and infrequency data. For example, in some applications of mobile devices, SDT may involve traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may involve sensor data (e.g., temperature, pressure readings transmitted periodically or in an event-triggered manner in an IoT network), metering and alerting information sent from smart meters, and/or the like.

In the context of the present disclosure, the terminal device 110 in an inactive state may communicate with the network device 120. In some embodiments, for example, the terminal device 110 may enter the inactivate state upon receiving an RRC release with suspendConfig.

In some scenarios, when the terminal device 110 has small and infrequency data traffic from radio bearer supporting a transmission in inactive state to be transmitted, the terminal device 110 may initiate a SDT procedure. Whether one radio bearer supporting a transmission in inactive state is configured by the network device 120 or other network device.

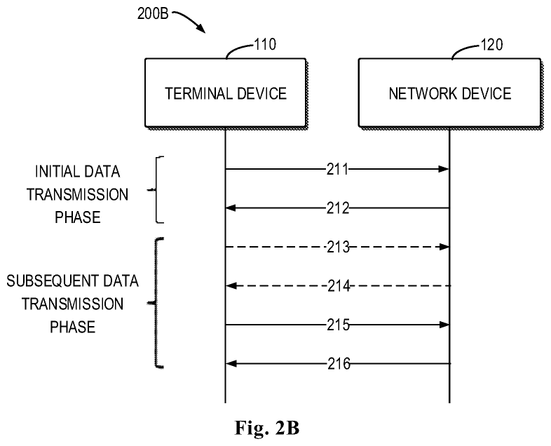

FIG. 2A illustrates a schematic diagram illustrating a SDT procedure 200A for one-shot in which some embodiments of the present disclosure can be implemented. The procedure shown in FIG. 2A only includes an initial data transmission phase. As shown in FIG. 2A, the terminal device 110 in an inactive state may transmit 201, to the network device 120, an RRC resume request message with UL data (i.e. uplink data, e.g., data transmitted using a SRB or DRB configured with SDT) associated with the data traffic. For example, the terminal device 110 may transmit the RRC resume request message with UL data in Msg A of a 2-step RACH procedure or in Msg3 of a 4-step RACH procedure. Of course, the terminal device 110 may also transmit the RRC resume request message with UL data in a configured grant (CG) resource. The RRC resume request message may include a resume MAC-I.

Upon receipt of the RRC resume request message and the UL data, the network device 120 may transmit 202 an RRC release message with DL data corresponding to the UL data to the terminal device 110. For example, the network device 120 may transmit the RRC release message with the DL data in Msg B of a 2-step RACH procedure or in Msg4 of a 4-step RACH procedure. Or the network device 120 may transmit the RRC release message with DL data as response of the transmission at the CG resource. Then, the SDT procedure 200A ends.

FIG. 2B illustrates a schematic diagram illustrating a SDT procedure 200B including an initial data transmission phase and a data subsequent data transmission phase in which some embodiments of the present disclosure can be implemented. As shown in FIG. 2B, the terminal device 110 in an inactive state may transmit 211, to the network device 120, an RRC resume request message with UL data and a buffer status report (BSR). For example, the terminal device 110 may transmit the RRC resume request message with the UL data and the BSR in Msg A of a 2-step RACH procedure or in Msg3 of a 4-step RACH procedure. Of course, the terminal device 110 may also transmit the RRC resume request message with UL data in a configured grant (CG) resource. The RRC resume request message may include a resume MAC-I.

Upon receipt of the RRC resume request message with the UL data and the BSR, the network device 120 may transmit 212 an indication of subsequent data transmission to the terminal device 110. For example, the network device 120 may transmit an explicit RRC message indicating the subsequent data transmission. As another example, the network device 120 may transmit an uplink grant (UL grant) for further transmission, so as to implicitly indicating the subsequent data transmission. In some embodiments, the network device 120 may also transmit DL data with the indication to the terminal device 110. So far, the initial data transmission is done.

Based on the indication, the terminal device 110 may transmit 213 further UL data and BSR to the network device 120, for example, based on a dynamic grant or configured grant. Then the network device 120 may transmit 214 an UL grant for dynamic grant to the terminal device 110. In some embodiments, the network device 120 may transmit DL data with the UL grant to the terminal device 110.

Based on the UL grant from the network device 120, the terminal device 110 may transmit 215 remaining UL data to the network device 120. Accordingly, the network device 120 may transmit 216 RRC release message to the terminal device 110. So far, subsequent data transmission is done. That is, the SDT procedure 200B ends. It should be understood that the SDT procedure 200B may include more or less steps in the subsequent data transmission and the protection scope of the present disclosure is not limited in this regard.

In the above part, possible SDT procedures are illustrated with reference to FIGS. 2A and 2B. In the following part, some specific scenarios related to SDT will be introduced.

It should be appreciated that, throughout this disclosure, the term “during SDT” can be used interchangeably with “a timer for SDT is running”. For example, the timer may be started upon SDT is initiated.

However, the inventor of the present disclosure noticed that, in order to provide a more robust and secure solution for SDT there are still some issues in specific scenarios (e.g., handling of RLC re-establishment for SDT, on-demand SI/PI during SDT, SDT abortion, security issue related to resumeMAC-I calculation, power headroom report (PHR) and the like) that needs to be solved. In order to solve these issues or issues in other potential scenarios, embodiments of the present disclosure provide solutions of communication for handling the issues during the SDT procedure.

It should be noted that, the details of the above mentioned issues for each scenario discovered and their corresponding solutions will be introduced in the following part, respectively. Principles and implementations of the present disclosure will be described in detail below with reference to the figures.

### Example Implementation of Handling of RLC Re-Establishment for SDT

When upper layers (e.g., RRC) request an RLC entity re-establishment, the terminal device 110 may discard all RLC service data units (SDUs), RLC SDU segments, and RLC protocol data units (PDUs), if any. In addition, during the RLC entity re-establishment, all timers will be stopped and reset. Further, the process will reset all state variables to their initial values.

In one example, one of the purposes of RLC entity re-establishment is used to avoid the buffered data from being transmitted in the subsequent data transmission, since the buffered data (e.g., data which is supposed to be transmitted when the terminal device 110 is located in a previous cell) is ciphered using old keys. If the buffered data is transmitted by the terminal device 110 when it moves to a new cell), there will be errors to occur. Therefore, the buffered data should be discarded and will not be transmitted.

The reestablishRLC is used to indicate that RLC should be re-established. Network device 120 sets this to true at least whenever the security key used for the radio bearer associated with this RLC entity changes. For SRB2 and DRBs, it is also set to true during the resumption of the RRC connection or the first reconfiguration after reestablishment.

However the inventor of the present disclosure noticed that an RLC entity re-establishment is only performed when the network device 120 configures RLC re-establishment (i.e., reestablishRLC) to the terminal device 110. Whereas, for the case of SDT, the terminal device 110 will transmit an RRC resume request message with uplink data (e.g., data transmitted using a SRB or DRB configured with SDT) sent directly as mentioned above with reference to FIGS. 2A and 2B, and at this point of time the terminal device 110 has not received the configuration (e.g., reestablishRLC) from the network device 120. In other words, it is not possible for the network device 120 to configure (e.g., reestablishRLC) upon initialization of SDT. Accordingly, if RLC re-establishment is not performed for the SDT, there will be issues as mentioned above (e.g., the buffered old data will be transmitted which is not expected). Therefore, the RLC entity re-establishment needs to be performed before or when the SDT is initiated.

In view of this, embodiments of the present application provide solutions of handling RLC entity re-establishment for SDT. In this solution, the terminal device 110 first determine whether a RLC entity re-establishment for a radio bearer is to be performed, and the radio bearer is configured with a transmission of data in an inactive state. Then, if it is determined that the RLC entity re-establishment is to be performed, the terminal device 110 re-establishes the RLC entity. After that, the terminal device 110 transmits, to a network device 120, uplink data in the inactive state on the radio bearer. In this way, an RLC entity re-establishment is able to be handled for radio bearer configured with SDT if the terminal device 110 determines that the RLC entity re-establishment needs to be performed for the SDT, thereby improving performance of the SDT procedure.

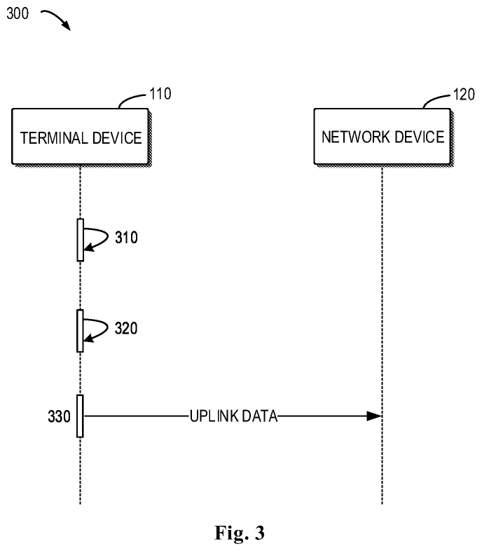

Reference is now made to FIG. 3, which illustrates a signaling flow 300 for a SDT procedure according to some embodiments of the present disclosure. For the purpose of discussion, the signaling flow 300 will be described with reference to FIG. 1A. The signaling flow 300 involves the terminal device 110 and the network device 120 as illustrated in FIG. 1A.

As shown in FIG. 3, the terminal device 110 determines 310 whether a RLC entity re-establishment for a radio bearer is to be performed. The radio bearer is configured with a transmission of uplink data in an inactive state (i.e. radio bearer configured with SDT).

In some embodiments, the terminal device 110 may determine whether the transmission of the uplink data is to be performed in the inactive state. If the transmission of the uplink data is to be performed in the inactive state, the terminal device 110 may determine that the RLC entity re-establishment is to be performed. As such, RLC re-establishment is able to be performed implicitly at the terminal device 110 for a radio bearer configured with SDT, that is, without explicit indication for RLC re-establishment for the network.

In some other embodiments, if an RRC release message is received from the network device 120, and the RRC release message includes an indication on the RLC entity re-establishment for the radio bearer configured with a transmission of uplink data in an inactive state, the terminal device 110 may determine that the RLC entity re-establishment is to be performed. As such, the network device 120 can configure reestablishRLC for the SDT radio bearer in RRCRelease with suspendConfig, such that the RLC entity re-establishment is able to be handled for a radio bearer configured with SDT.

It should be appreciated that the terminal device 110 may also determine the RLC entity re-establishment is to be performed in other ways and the scope of the present disclosure is not limited in this regard.

After it is determined that the RLC entity re-establishment is to be performed, the terminal device 110 may re-establish 320 the RLC entity. In some embodiments, when upper layers (e.g., PDCP, RRC or NAS) of the terminal device 110 request an RLC entity re-establishment, the RLC layer of the terminal device 110 may discard all RLC SDUs, RLC SDU segments, and RLC protocol data units (PDUs), if any. In some other embodiments, during the RLC entity re-establishment, the terminal device 110 may also stop and reset all timers. Alternatively, the terminal device 110 may reset all state variables to their initial values. The RLC layer of the terminal device 110 may also perform other actions so as to re-establish the RLC entity and the scope of the present disclosure is not limited in this regard.

Upon re-establishing the RLC entity, the terminal device 110 transmits 330, to the network device 120, uplink data in the inactive state on the radio bearer. In some embodiments, the terminal device 110 may use RA-based or CG-based SDT as introduced with reference to FIGS. 2A and 2B to transmit uplink data in the inactive state.

In some examples, if CG-based SDT criteria is met, the terminal device 110 may select CG-based SDT. Else if RA-based SDT criteria is met, the terminal device 110 may select RA-SDT.

In such examples, the CG-SDT criteria may be considered met, if one or more of the following conditions is met: 1) available data volume <=data volume threshold; 2) reference signal received power (RSRP) is greater than or equal to a configured threshold; or 3) CG-based SDT resources are configured on the selected UL carrier and are valid. Meanwhile, RA-based SDT criteria is considered met, if one or more of the following conditions is met, 1) available data volume <=data volume threshold: 2) RSRP is greater than or equal to a configured threshold: 3) 4 step RA-based SDT resources are configured on the selected UL carrier and criteria to select 4 step RA-based SDT is met: or 2 step RA-based SDT resources are configured on the selected UL carrier and criteria to select 2 step RA-based SDT is met.

With the above solution, for example, the buffered old data which is not expected will not be transmitted during SDT. A more robust SDT solution is able to be provided.

Currently, the network device 120 may transmit an RRC Resume message to the terminal device 110 during SDT to indicate the terminal device 110 to transfer to non-SDT mode. According to the conventional solution, the network device 120 may indicate an RLC re-establishment when resuming an RRC connection. However, for the SDT radio bearers, if the network device 120 indicates RLC re-establishment, the buffered RLC packets will be clean up which results in packets loss.

In order to solve the above problem, in some embodiments, when uplink data and a radio resource control, RRC, resume request message is received from a terminal device 110 in an inactive state, the network device 120 may transmit, to the terminal device 110, an RRC resume message. The RRC resume message may include an indication for a RLC entity re-establishment for a radio bearer not configured with a transmission of data in an inactive state.

Upon receiving, from the network device 120, the RRC resume message, the terminal device 110 may re-establish an RLC entity for transmitting data in a connected state. In order words, the network device 120 only configures reestablishRLC for non-SDT radio bearers in the RRC resume message during SDT. As a result, for SDT radio bearers, the buffered RLC packets will not be cleaned up.

Accordingly, for example, the related content of the modified 3GPP specification would be as below: the reestablishRLC indicates that RLC should be re-established. Then, the network device 120 may set this to true at least whenever the security key used for the radio bearer associated with this RLC entity changes. For SRB2 and DRBs, it is also set to true during the resumption of the RRC connection or the first reconfiguration after reestablishment. It is only indicated to the radio bearers not supporting SDT when resuming an RRC connection during SDT.

It should be appreciated that this solution (i.e. the network device 120 to transmit, to the terminal device 110, an RRC resume message including an indication for a RLC entity re-establishment for a radio bearer not configured with a transmission of data in an inactive state) may work independently or together with the solution of handling RLC entity re-establishment for SDT mentioned above, and the scope of the present disclosure is not limited in this regard.

### Example Implementation of on Demand System/Position Information Request

System information (SI) includes minimum SI and other SI. Minimum SI includes basic information required for initial access and information for acquiring any other SI. The minimum SI is consist of master information block (MIB) and system information block 1 (SIB1).

In some examples, other SI encompasses all SIBs not broadcast in the Minimum SI. In such examples, for example, those SIBs may be periodically broadcasted on DL-SCH. In another example, the SIBs may also be broadcasted on-demand on DL-SCH (i.e. upon request from the terminal device 110 in RRC_IDLE, RRC_INACTIVE, or RRC_CONNECTED). Alternatively, those SIBs may be sent in a dedicated manner on DL-SCH to UEs in RRC_CONNECTED (i.e., upon request, if configured by the network, from UEs in RRC_CONNECTED or when the UE has an active BWP with no common search space configured).

Further, besides SI, in some examples, the terminal device 110 may also need to obtain position information (PI). In such examples, the PI may also be broadcasted by the network device 120 when requested by the terminal device 110 (i.e., broadcast on demand). As such, the position of the terminal device 110 may be obtained via parameters included in the PI broadcasted from the network device 120.

However, the inventor of the present disclosure noticed that during SDT (i.e., uplink transmission by the terminal device 110 in an inactive state), the terminal device 110 may need to request for on-demand SI/PI. As such, in one aspect, the request for on-demand SI/PI may be transmitted together with the uplink data transmission in an inactive state in an initial uplink SDT transmission. That is, two CCCH messages (since both the RRC resume request message and the RRC_System_Info_Request message are transmitted via CCCH message) needs to be transmitted at the same time. However, in conventional solutions, the size of UL grant is designed for at least one CCCH message and the mode of RLC for CCCH message is transparent mode (TM), meaning that a CCCH message should not be segmented when being transmitted. That is, if the size of an UL grant is not enough for transmitting two CCCH messages, the second CCCH message cannot be transmitted in a separated manner (i.e., part of the CCCH message is transmitted in this UL grant and the other part of the CCCH message is transmitted in the next UL grant). Accordingly, when the two CCCH messages are transmitted in an UL grant, and size of the UL grant is too small to hold two CCCH messages, it may result in failing to transmit the second one of the two CCCH messages.

In another aspect, the inventor also noticed that when there is a subsequent uplink data transmission in an inactive state after the initial uplink SDT transmission, the terminal device 110 may continue performing the transmission in the inactive state. At this time, if the terminal device 110 needs to request for on-demand SI/PI, there is no solution on how to transmit the request for the on-demand SI/PI together with the subsequent SDT transmission in a subsequent data transmission phase. In other words, there is no solution on how to transmit a CCCH message during subsequent uplink data transmission phase for a terminal device 110 in the inactive state. Accordingly, for example, it might be problematic when the size of the UL grant for the subsequent uplink data transmission is not enough for the CCCH message, considering that the CCCH message cannot be segmented as mentioned above.

In some other aspects, on-demand SI/PI may also be obtained via a RACH procedure; meanwhile, the initial data transmission phase for an uplink transmission in an inactive state (i.e. a SDT) is able to be performed via a RA-based SDT as mentioned above. As a result, two parallel RACH procedures (i.e., one for on-demand SI/PI and the other one for initial data transmission phase for the uplink transmission in the inactive state) might be triggered which is not allowed. However, since the MAC entity of the terminal device 110 only allows one RACH procedure to be performed. As a result, triggering two parallel RACH procedures is also problematic.

To sum up, there is no solution on how to deal with the above mentioned problematic scenarios. In other words, a solution is needed for scenario in which on-demand SI/PI information request is triggering during SDT.

In order to solve at least one of the above issues, a solution of SDT is provided. In this solution, the terminal device 110 performing a transmission of uplink data in an inactive state (i.e. a terminal device 110 performing SDT) first determines whether on-demand information is available. If it is determined that the on-demand information is unavailable, the terminal device 110 performs at least one of the following. First, the terminal device 110 triggers a transmission of a request for the on-demand information to a network device 120. Alternatively, the terminal device 110 avoids the transmission of the request for the on-demand information to the network device 120. In other word, the terminal device 110 will not transmit the request for the on-demand information to the network device 120.

As such, the terminal device 110 is able to allow the request for the on-demand information (e.g., on-demand SI/PI) during SDT or avoid the on-demand information request to be transmitted during SDT. As such, the on-demand information request triggered during SDT can be handled properly (e.g., without interrupting the existing SDT), thereby improving robustness of the SDT solution.

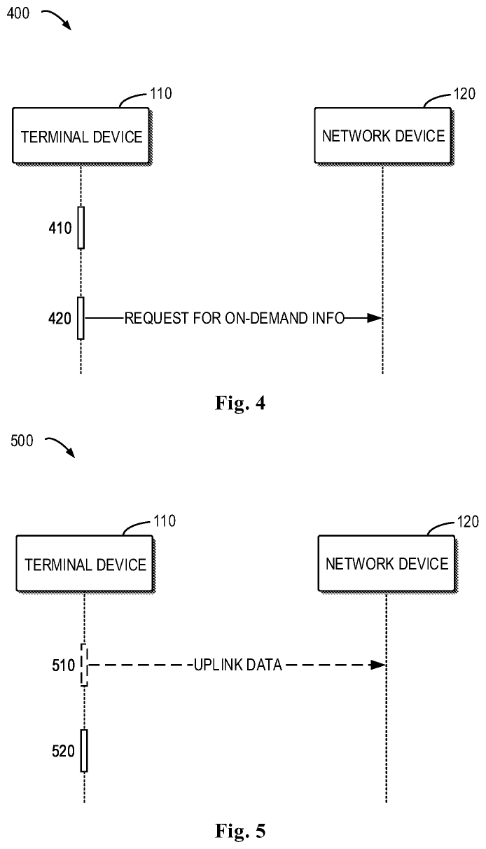

Reference is now made to FIG. 4, which illustrates a signaling flow 400 for a SDT procedure according to some embodiments of the present disclosure. For the purpose of discussion, the signaling flow 400 will be described with reference to FIG. 1A. The signaling flow 300 involves the terminal device 110 and the network device 120 as illustrated in FIG. 1A.

As shown in FIG. 4, the terminal device 110 performing a transmission of uplink data in an inactive state determines 410 whether on-demand information is available. In one example, the on-demand information may include on-demand SI. In another example, the on-demand information may also include on-demand PI. It should be appreciated that the on-demand information may also include other type of on-demand information and the scope of the present disclosure is not limited in this regard.

In some embodiments, the terminal device 110 may determine whether on-demand information is available. If not, the terminal device 110 may determine whether it is performing a transmission of uplink data in an inactive state (i.e. SDT). If yes, the terminal device 110 may trigger a transmission of a request for the on-demand information to the network device 120 or avoid the transmission of (i.e. will not transmit) the request for the on-demand information to the network device 120.

In some embodiments, if it is determined that there is no valid version of the on-demand information and the on-demand information is not being broadcasted by the network device 120, the terminal device 110 may determine the on-demand information is unavailable. In such embodiments, for example, there is no valid version of the on-demand information may be that terminal device 110 has not stored a valid version. In another example, it may be that the terminal device has not stored any version of the on-demand information at all.

In some other embodiments, if it is determined that the request for the on-demand information is received at an RRC layer from an upper layer of the terminal device 110 and the one-demand information is not being broadcasted by the network device 120, the terminal device 110 may determine that the on-demand information is unavailable. The terminal device 110 may also determine whether the on-demand information is available or unavailable, and the scope of the present disclosure is not limited in this regard.

Then, if it is determined that the on-demand information is unavailable, the terminal device 110 determines 420 to trigger a transmission of a request for the on-demand information to a network device 120. Alternatively, the terminal device 110 avoids the transmission of the request for the on-demand information to the network device 120. In order words, the terminal device 110 will not request for on-demand SI or on demand PI during SDT. In such case, the terminal device 110 may postpone the request after the SDT procedure. In some other embodiments, if it is determined that the on-demand information is unavailable, and the terminal device 110 is not performing SDT (i.e., the timer for SDT is not running), the terminal device 110 may request for the on-demand SI/PI.

The terminal device 110 may trigger the transmission of the request for the on-demand information to the network device 120 in a variety of way. In the following part, ways on how to trigger the transmission of the request will be introduced in details. However, it should be appreciated there will also be other ways to trigger the transmission of the request and the scope of the present disclosure is not limited in this regard.

In some embodiments, the terminal device 110 may enter an idle state from inactive state and then transmit the request for the on-demand information to the network device 120. In such embodiments, in one example, the lower layer (e.g., MAC layer) of the terminal device 110 may be triggered to initiate the random access (RA) procedure on normal uplink in accordance with TS 38.321 using the PRACH preamble(s) and PRACH resource(s) in si-RequestConfig corresponding to the SI message(s) that the terminal device 110 requires to operate within the cell, and for which si-BroadcastStatus is set to notBroadcasting. As such, the on-demand information may be obtained from the network device 120 accordingly.

In another example, the terminal device 110 may initiate transmission of the RRCSystemInfoRequest message (i.e., a SRB0 message using CCCH) in accordance with existing 3GPP standard to request for the on-demand SI/PI for the terminal device 110 under INACTIVE state or IDLE state.

In some other embodiments, the terminal device 110 may abort the transmission of the uplink data in the inactive state and then transmit the request for the on-demand information to the network device 120. For example, the terminal device 110 may abort the transmission of the uplink data in the inactive state by using the same abortion procedure to be described in the following part of the present disclosure. The terminal device 110 may also abort the transmission of the uplink data in the inactive state with other abortion procedures and the scope of the present disclosure is not limited in this regard.

In such embodiments, in one example, the lower layer (e.g., PHY layer) of the terminal device 110 may be triggered to initiate the RA procedure on normal uplink or supplementary uplink in accordance with TS 38.321 using the PRACH preamble(s) and PRACH resource(s) in si-RequestConfig or si-RequestConfigSUL corresponding to the SI message(s) that the terminal device 110 requires to operate within the cell, and for which si-BroadcastStatus is set to notBroadcasting. As such, the on-demand information may be obtained from the network device 120 accordingly.

In another example, the terminal device 110 may initiate transmission of the RRCSystemInfoRequest message (i.e., a SRB0 message using CCCH) in accordance with existing 3GPP standard to request for the on-demand SI/PI for the terminal device 110 under INACTIVE state or IDLE state.

Alternatively, the terminal device 110 may trigger the transmission of the request for the on-demand SI/PI by transmitting a SRB1 message or a SRB2 message. As such, since the SRB1 and SRB2 messages are transmitted in RLC acknowledgement mode (AM), segmentation is allowed for such mode. As a result, due to the request for on-demand SI/PI is transmitted using DCCH, there is no issue of whether the UL grant is big enough to accommodate the CCCH messages.

In such embodiments, for example, an existing SRB 1 or SRB2 message may be used. In the example, the existing DedicatedSIBRequest message may be used to transmit on demand SI/PI. In order to more types of SIBs, the content of the message may be extended to request for other SIBs (e.g., SIB2-SIB11) besides SIB12, SIB13, SIB14 which are currently support by the DedicatedSIBRequest message.

In such embodiments, in another example, a new designed message may be used to transmit the on-demand information using SRB1 or SRB2. Specifically, the content of the new message may be the same or similar to the RRCSystemInfoRquest.

In one example, the new designed message may be as below:

| | |
|---|---|
| NewMessage ::= | SEQUENCE { |
| criticalExtensions | CHOICE { |
| newMessage | RRCSystemInfoRequest-IEs, |
| criticalExtensionsFuture-r16 | CHOICE { |

rrcPosSystemInfoRequest-r16
RRC-PosSystemInfoRequest-r16-IEs,

| | |
|---|---|
| criticalExtensionsFuture | SEQUENCE { } |

```
    }
  }
}
```

| | |
|---|---|
| RRCSystemInfoRequest-IEs ::= | SEQUENCE { |
| requested-SI-List | BIT STRING (SIZE (maxSI-Message)), -- 32bits |
| spare | BIT STRING (SIZE (12)) |

}
RRC-PosSystemInfoRequest-r16-IEs ::= SEQUENCE {

| | |
|---|---|
| requestedPosSI-List | BIT STRING (SIZE (maxSI-Message)), -- 32bits |
| spare | BIT STRING (SIZE (11)) |

}

It should be appreciated that the SRB1 and SRB2 messages may also be designed in other format and the scope of the present disclosure is not limited in this regard.

In some embodiments, if an RA-based SDT is used and a RA procedure based request is triggered, considering that the RA based request cannot be performed during initial SDT phase of RA-based SDT, the terminal device 110 may postpone the RA based request and perform it after the initial SDT transmission (i.e. initial data transmission phase) is finished. Alternatively, in such case, the terminal device 110 may also transmit a SRB0 message (e.g., RRCSystemInfoRequest message) based request during the initial data transmission phase, instead of postponing the RA based request.

With the above solutions, when on-demand information is required during SDT and RA procedure based request is triggered, the scenarios in which two parallel RACH procedures are triggered is able to be avoided.

In some examples, the RA procedure based request for on-demand SI/on-demand PI may be performed during the subsequent data transmission phase of SDT. In some other example, the RA procedure based request may also be performed for on-demand SI/on-demand PI during CG-based SDT.

In some embodiments, as mentioned above with reference to FIGS. 2A and 2B, phase(s) for the transmission of the uplink data in the inactive state may include an initial data transmission phase and an additional subsequent data transmission phase in some cases. Accordingly, in such embodiments, for example, the terminal device 110 may determine the request for the on-demand SI/PI may be transmitted with a SRB0, message (e.g., the RRCSystemInfoRequest message), and the SRB0 message may be transmitted together with an RRC resume request message and the transmission of the uplink data in the inactive state in a medium access control protocol data unit, MAC PDU, during the initial data transmission phase.

In conventional solutions, a temporary cell-radio network temporary identifier (TC-RNTI) is used during RA procedure in an initial data transmission phase. Whereas, in a subsequent data transmission phase, when uplink grant for dynamic grant or configured grant are used, cell-radio network temporary identifier (C-RNTI) and configured scheduling-radio network temporary identifier (CS-RNTI) will be used respectively. However, in conventional solutions, both the C-RNTI and CS-RNTI are not allowed to transmit UL CCCH message. As a result, even if the CCCH is able to be segmented, it is still problematic when transmitting the CCCH message in the subsequent data transmission phase. That is, it is required to allow C-RNTI and CS-RNTI to be used to transmit UL CCCH message for on demand SI/PI during the subsequent data transmission phase of SDT.

In order to solve the above mentioned problem, in another example, the terminal device 110 may transmit the SRB0 message during the subsequent data transmission phase on a CCCH using a C-RNTI or a CS-RNTI. For example, the related content of the modified 3GPP specification would be as in Table 1 below:

TABLE 1
RNTI Usage

| RNTI | Usage | Transport Channel | Logical Channel |
|---|---|---|---|
| P-RNTI | Paging and System Information change | PCH | PCCH |
| | notification | | |
| SI-RNTI | Broadcast of System Information | DL-SCH | BCCH |
| RA-RNTI | Random Access Response | DL-SCH | N/A |
| MSGB-RNTI | Random Access Response for 2-step RA | DL-SCH | CCCH, DCCH |
| | type | | |
| Temporary | Contention Resolution | DL-SCH | CCCH, DCCH |
| C-RNTI | (when no valid C-RNTI is available) | | |
| Temporary | Msg3 transmission | UL-SCH | CCCH, DCCH, DTCH |
| C-RNTI | | | |
| C-RNTI, | Dynamically scheduled unicast | UL-SCH | CCCH, DCCH, DTCH |
| MCS-C-RNTI | transmission | | |
| C-RNTI | Dynamically scheduled unicast | DL-SCH | CCCH, DCCH, DTCH |
| | transmission | | |
| MCS-C-RNTI | Dynamically scheduled unicast | DL-SCH | DCCH, DTCH |
| | transmission | | |
| C-RNTI | Triggering of PDCCH ordered random | N/A | N/A |
| | access | | |
| CS-RNTI | Configured scheduled unicast transmission | DL-SCH, UL-SCH | CCCH, DCCH, DTCH |
| | (activation, reactivation and | | |
| | retransmission) | | |

Accordingly, the C-RNTI and CS-RNTI are able to be used to transmit the UL CCCH message, such that on-demand system information request is able to be initiated during SDT.

In some other embodiments, the terminal device 110 may determine the request for the on-demand information is transmitted using SRB0 message. Accordingly, upon determining that an uplink grant accommodates the uplink data and does not additionally accommodate the SRB0 message, the terminal device 110 may transmit the request after entering an idle state. Alternatively, the terminal device 110 may transmit the request after aborting the transmission of the uplink data in the inactive state. In one example, the terminal device 110 may abort the transmission of the uplink data in the inactive state by using the same abortion procedure to be described in the following part of the present disclosure. The terminal device 110 may also abort the transmission of the uplink data in the inactive state with other abortion procedures and the scope of the present disclosure is not limited in this regard.

In other words, if the UL grant cannot accommodate the data of CCCH message, the MAC layer shall indicate to the RRC layer. Accordingly, the RRC layer of the terminal device 110 may perform SDT abortion procedure or go to an idle mode, and then initiates request for on-demand information. As such, the on-demand information (e.g., SI/PI) is able to be obtained by the terminal device 110 even if it is triggered during SDT procedure.

### Example Implementation of Termination of SDT Procedure

The inventor of the present disclosure noticed that during the SDT procedure, there may be some cases in which the SDT procedure cannot continue to be performed. As such the SDT procedure is better to be terminated. However, it is still unclear what should the terminal device 110 perform upon such cases so as to terminate the SDT procedure.

Further, the inventor of the present disclosure discovers a plenty of scenarios in which it is unclear what the terminal device 110 should do once such any of them happens. Specifically, in one scenario, when terminal device 110 just transmits an initial SDT by transmitting an RRC resume request message and the uplink data, for example, and the network device 120 has not received this initial data transmission due to a delay or failure in a network. At this time, if the terminal device 110 receives a paging request (e.g., when there is an incoming call), it is better that a response to the paging request is provided rather than continuing performing the SDT. It is because the SDT has lower priority than the paging request causes by, for example, the incoming call. In such scenario, how should the SDT procedure be processed by the terminal device 110?

Furthermore, in another scenario, an upper layer (e.g., NAS layer) of the terminal device 110 may trigger a RRC Resume procedure to the RRC layer, and the SDT procedure is initiated by the RRC layer, for example. However, after that, the upper layer may indicate to the RRC layer to give up the RRC Resume procedure, that is, to abort the RRC connection establishment. In such case, how should the SDT procedure be process by the terminal device 110?

In another scenario, a timer is introduced and is used to determine whether a transmission of uplink data fails. For example, the timer may be a timer which is initiated once a SDT procedure is initiated by RRC layer. Alternatively, the timer may also be a timer initiated or reset when transmission of uplink data is performed at the terminal device 110 during subsequent data transmission phase.

In normal scenarios, the timer which is set with a maximum value should not expire during SDT procedure and there should be a response from the network device 120 before the expiration of the timer. However, if the timer expires and there is no response from the network device 120 (e.g., due to delay of the network, a network failure and the like), the terminal device 110 may determine that the transmission of uplink data fails. In such scenarios, how should the SDT procedure be process by the terminal device 110?

In another scenario, when an RLC transmission fails, a RLC retransmission will happen. If this RLC retransmission fails, there might also be another RLC retransmission. For such scenario, a maximum number of RLC retransmissions (e.g., 2 or 4 RLC retransmissions) may be defined. During the SDT, when the maximum number of RLC retransmissions is reached, it might mean that the channel condition at this point of time is poor. In such scenarios, how should the SDT procedure be process by the terminal device 110?

In addition, an initial uplink data transmission in the Msg A or Msg 3 resource of a RA-based SDT or in a CG resource of a CG-based SDT fails a predetermined number of times, how should the SDT procedure further be performed by the terminal device 110?

In a further scenario, RRC layer of the terminal device 110 may determine the all the radio bearers with new data are configured supporting SDT and the amount of data is below a threshold, then the RRC layer will indicate to the MAC layer of the terminal device 110 such that the MAC layer will select whether to perform RA-based SDT or CG-based SDT. If neither suitable RA-based SDT resource nor CG-based SDT resource is available, the MAC layer should indicate to the RRC layer of the terminal device 110 to cancel the SDT duel to no suitable SDT resource is available. At this point of time, the RRC layer of the terminal device 110 might has finish the RLC re-establishment mentioned above or other SDT-related process. However, since the MAC layer of the terminal device 110 has indicated to the RRC layer about the unavailability of the SDT resource, how should the terminal device 110 perform?

In order to solve at least one of the above issues, a solution for terminating the SDT is provided. Reference is now made to FIG. 5, which illustrates a signaling flow 500 for a SDT procedure according to some embodiments of the present disclosure. For the purpose of discussion, the signaling flow 500 will be described with reference to FIG. 1A. The signaling flow 500 involves the terminal device 110 and the network device 120 as illustrated in FIG. 1A.

As shown in FIG. 5, for example, the terminal device 110 may be transmitting 510 uplink data in an inactive state to a network device 120. In another example, the terminal device 110 may about to transmit uplink data in an inactive state to a network device 120 but has not transmitted it. Then, in response to one of the following the terminal device 110 aborts 520 the transmission of the uplink data in the inactive state (i.e., SDT procedure): receiving a paging message addressing the terminal device 110 from the network device 120, receiving, at an RRC layer of the terminal device 110 an abortion of a connection establishment from a non-access stratum layer, an expiration of a first timer related to the transmission of the uplink data in the inactive state, a maximum number of RLC retransmissions has been reached, an initial uplink data transmission (in MsgA/Msg3/CG resources) fails a predetermined number of times, and an indication being provided from an MAC layer of the terminal device 110 to the RRC layer to cancel the transmission of the uplink data in the inactive state.

In some embodiments, the terminal device 110 may abort the SDT procedure in response to receiving a message (e.g., RRCReject message) for rejecting the transmission. In some examples, the terminal device 110 may abort the SDT procedure in response to further uplink data arriving from at least one radio bearer not supporting a transmission in the inactive state (i.e., not supporting SDT). In some examples, the terminal device 110 may abort the SDT procedure in response to the NAS layer or AS layer requesting transition to RRC Connected state. In some embodiments, the terminal device 110 may abort the SDT procedure in response to receive signal power (for example, RSRP) of a serving cell of the terminal device 110 being lower than a threshold power. In some embodiments, the terminal device 110 may abort the SDT procedure in response to a cell reselection being performed from a first cell to a second cell. These merely are examples, any other suitable conditions may also be feasible for aborting the SDT procedure.

In some embodiments, the terminal device 110 may abort the SDT procedure by stopping a timer related to the transmission of the uplink data in the inactive state. Accordingly, once the timer is stopped, expiration of the timer would not be triggered such that no other unexpected behavior will be triggered.

In some other embodiments, the terminal device 110 may also abort the SDT procedure by at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state (i.e., all radio bearers or only radio bearers supporting SDT); suspending SRB1 and at least radio bearers supporting a transmission in the inactive state (i.e., all radio bearers or only radio bearers supporting SDT). It is to be noted that more or less actions may also be included in aborting the SDT procedure.

With the above solution, it is clear in which scenarios an on-going SDT procedure should be terminated. And the terminal device 110 may abort the SDT procedure in case of the listed scenario happens, thereby providing a more robust SDT solution.

In some other embodiments, the terminal device 110 may also enter the idle state in response to one of the following: receiving a paging message addressing the terminal device 110 from the network device 120, receiving, at an RRC layer of the terminal device 110 an abortion of a connection establishment from a non-access stratum layer, an expiration of a first timer related to the transmission of the uplink data in the inactive state, a maximum number of RLC retransmissions has been reached, an initial uplink data transmission (in MsgA/Msg3/CG resources) fails a predetermined number of times, and an indication being provided from an MAC layer of the terminal device 110 to the RRC layer to cancel the transmission of the uplink data in the inactive state.

With the above solution, the terminal device 110 can also enter the idle state in case of the listed scenario happens, thereby providing a more robust and complete solution for SDT.

It should be appreciated that upon entering the idle state (i.e. RRC_IDLE), the terminal device 110 may perform according to that is defined in the existing 3GPP standards and the details of which will not be specified herein.

### Example Implementation of Second RRC Resume

In some embodiments, as mentioned above, SDT abortion may be performed after the SDT procedure is initiated due to a variety of reasons. And after the SDT abortion, the terminal device 110 may stay in the inactive state. When in the inactive state, the terminal device 110 may initiate an RRC resume procedure in the same cell again. The inventor of the present disclosure noticed that there is some security concern if the same resumeMAC-I is used in such kind of scenario.

Specifically, ResumeMAC-I is information transmitted by the terminal device 110 in RRC resume request message to the network device 120, such that the network device 120 may use it to verify whether the terminal device 110 is a legitimate terminal device 110. It should be appreciated that the RRC resume request message may be an RRCResumeRequest or RRCResumeRequest1 message.

However, the problem is that the ResumeMAC-I has been calculated in a previous SDT procedure which happens before the SDT abortion procedure. However, since the RRC resume procedure (e.g., for SDT or for non-SDT) is performed in the same cell again using the same UE context, the ResumMAC-I may be calculated again, such that the ResumeMAC-I calculated in the second time might be the same as that has been calculated in the previous SDT procedure. As a result, if someone with another device (e.g., another terminal device 110) obtains the ResumeMAC-I calculated in the previous SDT procedure prior to the abortion procedure through interception, then this person with the device is able to pretend to be the terminal device 110 and transmit the second RRC resume request message to the network device 120.

In order to prevent the above case from happening, it is better that the ResumeMAC-I that has been used for one time is not reused next time in the following SDT/non-SDT procedure. Accordingly, a solution for the second RRC resume is provided. In the solution, the terminal device 110 determines a parameter of message authentication code-integrity, MAC-I, for an RRC resume procedure based on a first value related to the RRC resume procedure. Then, the terminal device 110 transmits an RRC resume request message including the parameter to initiate the RRC resume procedure. In such solution, the first value is different from a value for determining the MAC-I of another RRC resume procedure (e.g., a RRC resume procedure happened before the SDT abortion procedure).

With the above solution, during the second RRC resume procedure, the parameter of MAC-I (e.g., resumeMAC-I) is able to be calculated using a different input value for the COUNT and/or BEARER and/or DIRECTION for respective scenarios, thereby improving security of the network.

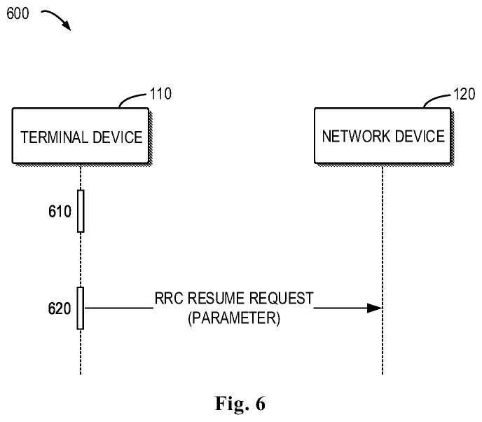

Reference is now made to FIG. 6, which illustrates a signaling flow 600 for a SDT procedure according to some embodiments of the present disclosure. For the purpose of discussion, the signaling flow 600 will be described with reference to FIG. 1A. The signaling flow 300 involves the terminal device 110 and the network device 120 as illustrated in FIG. 1A.

As shown in FIG. 6, the terminal device 110 determines 610 a parameter of MAC-I for an RRC resume procedure based on a value related to the RRC resume procedure. The value related to the RRC resume procedure is different from a value for determining the MAC-I of another RRC resume procedure. In some examples, the parameter of MAC-I may be resumeMAC-I.

In some examples, the value for determining the MAC-I of another RRC resume procedure may be a predetermined value which is a sequence of binary ones. For example, if it is a sequence of 16 bits, then the predetermined value may be 1111, 1111, 1111, 1111. In some other embodiments, the predetermined value may be 11 or 1111 and the embodiments of the present disclosure is not limited in this regard.

In some embodiments, the value related to the RRC resume procedure may be input bits of count for determining the resumeMAC-I. In some other embodiments, the value may be input bits of bearer for determining the resumeMAC-I. Alternatively, the value may be an input bit of direction for determining the resumeMAC-I. In other embodiments, the value may also be input bits of the count, bearer and direction or any combination thereof.

In some embodiments, the terminal device 110 may determine the parameter in response to determining that the RRC resume procedure is initiated after aborting a transmission of a further uplink data in an inactive state.

In such embodiments, for example, if the terminal device 110 performs a second RRC resume procedure (for SDT or legacy data transmission) in the same cell using the same UE Context later, the terminal device 110 sets the resumeMAC-I in RRCResumeRequest or RRCResumeRequest1 to the 16 least significant bits of the MAC-I calculated with a pre-defined input value for count and/or bear and/or direction other than all binary ones (e.g., all binary zeros, a sequence consisting of binary ones and zeros and the like):
2> over the ASN.1 encoded as per clause 8 (i.e., a multiple of 8 bits) VarResumeMAC-Input;
2> with the KRRCint key in the UE Inactive AS Context and the previously configured integrity protection algorithm; and
2> with input bits for count and/or bearer and/or direction set to predefined value which is not all binary ones.

With the above solution, a different resumeMAC-I is able to be used after SDT abortion when the terminal device 110 initiate an RRC resume procedure in the same cell again, thereby improving security of the system.

In some other embodiments, the terminal device 110 may also determine the parameter in response to determining the RRC resume procedure is for the transmission of the uplink data in the inactive state.

In such embodiments, for example, if the terminal device 110 initiates an RRC resume procedure for SDT, the terminal device 110 may calculate resumeMAC-I with input bits for count and/or bearer and/or direction set to predefined value which is not all binary ones (e.g. all binary zeros and the like). Otherwise, the terminal device 110 calculates the resumeMAC-I the same as in conventional solution, i.e. set to all binary ones.

Now returning back to FIG. 6, upon determining the parameter of MAC-I for the RRC resume procedure, the terminal device 110 transmits 620 an RRC resume request message including the parameter to initiate the RRC resume procedure.

In some examples, the RRC resume request including resumeMAC-I may be transmitted by the terminal device 110 to the network device 120 as following:

| | |
|---|---|
| RRCResumeRequest ::= | SEQUENCE { |
| rrcResumeRequest | RRCResumeRequest-IEs |

}

| | |
|---|---|
| RRCResumeRequest-IEs ::= | SEQUENCE { |
| resumeIdentity | ShortI-RNTI-Value, |
| resumeMAC-I | BIT STRING (SIZE (16)), |
| resumeCause | ResumeCause, |
| spare | BIT STRING (SIZE (1)) |

}

Furthermore, the state variable TX_NEXT indicates the count value of the next PDCP SDU to be transmitted. In some embodiments, an initial value of the state variable is 0, except for SRBs configured with state variables continuation. In some embodiments, for target SRB configured with state variables continuation, the initial value is the value stored in PDCP entity for the corresponding source SRB. For source SRB configured with state variables continuation, the initial value is the value stored in PDCP entity for the corresponding target SRB.

During a PDCP entity suspend procedure, the TX_NEXT is set to the initial value. which is currently performed upon the terminal device 110 entering inactive state.

During the RRC resume procedure, a PDCP re-establishment is performed where a state variable TX_NEXT for unacknowledged mode (UM) DRBs and SRBs is set to an initial value.

In this case, if the RRC resume procedure is triggered in the same cell as that for the previous SDT procedure using the current UE context, the packets to be transmitted during or after the RRC resume procedure by SDT or legacy data transmission will be ciphered using the same security key and COUNT value as that for the previous transmitted packets. However, the packets to be transmitted during or after the RRC resume procedure may be different from the previous transmitted packets in the previous SDT procedure. Thus, this will results in different packets being ciphered using the same security key and COUNT value, which is not allowed from safety point of view:

In view of this, embodiments of the present application provide solutions for handling the security issues in order to not resetting the state variable TX_NEXT.

As mentioned above, in some scenarios, a SDT procedure may be interrupted, and then the terminal device 110 may trigger another RRC resume procedure at the same cell in which the SDT procedure has been performed. This embodiment is directed to provide a solution for enhancing a security in these scenarios, which will be detailed below:

In such embodiments, the terminal device 110 may transmit uplink data in an inactive state to the network device 120. In other words, the terminal device 110 performs a SDT procedure. In some embodiments, the terminal device 110 may abort the SDT procedure.

During the SDT procedure, the terminal device 110 may determine whether a resume of a connection with the network device 120 is to be performed at a cell where the SDT procedure has been performed. If the resume of the connection is to be performed at the cell, the terminal device 110 may perform the resume of the connection as to be described below:

For example, the terminal device 110 may maintain a state variable (i.e., TX_NEXT) of PDCP entities of unacknowledged mode (UM) DRBs or SRBs in the PDCP re-establishment for the resume of the connection. That is, the TX_NEXT of PDCP entities of the UM DRBs or SRBs is not set to the initial value in the RRC resume procedure. In this way, the first packet to be transmitted upon the RRC resume procedure can be ciphered with a different COUNT value from that for the previous transmitted packet in the SDT procedure.

When the NAS layer or AS layer requests the terminal device 110 to resume RRC connection for SDT or legacy data transmission, if this is the cell where the terminal device 110 has performed the SDT procedure using the current UE context, the terminal device 110 may perform the following behavior in the RRC resume procedure. For example, in case of legacy data transmission, the network device 120 may configure the terminal device 110 to perform PDCP re-establishment for DRB, SRB1 and SRB2 in RRC resume message. In case of SDT, the RRC layer of the terminal device 110 may initiate PDCP re-establishment for the DRB or SRBs (e.g., SRB1 or SRB2) configured with SDT. When the RRC layer indicates PDCP entities of the radio bearer configured with SDT to perform re-establishment, the RRC layer shall also indicate to PDCP that TX_NEXT not initialized during the re-establishment for UM DRBs and SRBs.

In some embodiment, if the other RRC resume procedure (i.e., the second RRC procedure) is for legacy data transmission (i.e., data transmission during connected state), considering that there is only security issue for SDT bearers rather than non-SDT bearers, the network device 120 may configure in the RRC resume message in one of the following ways.

For example, in the RRC resume message, the network device 120 may configure PDCP re-establishment for the SDT bearers and non-SDT bearers, and the RRC layer of the terminal device 110 may indicate the PDCP layer that TX_NEXT continuation for the radio bearer supporting SDT when perform PDCP re-establishment.

Alternatively, in the RRC resume message, the network device 120 may configure PDCP re-establishment for radio bearers not supporting SDT. Meanwhile, the network device 120 may configure a PDCP recovery for the DRB supporting SDT and configure PDCP SDU discard for SRB1 and/or SRB supporting SDT. With the PDCP recovery, TX_NEXT will also not be reset as well for the radio bearer supporting SDT.

In some embodiments, if the resume of the connection is to be performed at a cell different from the cell where the SDT procedure has been performed, the terminal device 110 may perform the resume of the connection by initiating the state variable in the PDCP re-establishment. For example, the terminal device 110 may indicate PDCP suspend to lower layers of the DRBs before a PDCP re-establishment, and perform the PDCP re-establishment without indicating that TX_NEXT is not initialized.

For example, the related content of the modified 3GPP specification would be as below:
When upper layers request a PDCP entity re-establishment, the transmitting PDCP entity shall:
   for UM DRBs and AM DRBs, reset the ROHC protocol for uplink and start with an IR state in U-mode (as defined in RFC 3095 [8] and RFC 4815 [9]) if drb-ContinueROHC is not configured in TS 38.331 [3];
   for UM DRBs and AM DRBs, reset the EHC protocol for uplink if drb-ContinueEHC-UL is not configured in TS 38.331 [3];
   If the upper layers didn't indicate to maintain TX_NEXT value, for UM DRBs and SRBs, set TX_NEXT to the initial value:
for SRBs, discard all stored PDCP SDUs and PDCP PDUs.

### Example Implementation of Power Headroom Report

Currently, the PHR is used by the terminal device 110 to report to the network device 120 the usage status of uplink power. In the conventional solution, a PHR is triggered by the MAC layer of the terminal device 110 upon SDT. In addition, PHR has higher priority than data (e.g., DRB and SRB data).

Accordingly, during the initial data transmission phase, when RRC resume request (i.e. a CCCH message) is to be transmitted with uplink data in inactive state, and if at this point of time, a PHR is also need to be transmitted, then it might result in that the UL grant can only accommodate data (including UL CCCH, DCCH and DTCH) but cannot accommodate PHR MAC CE plus its header (three bytes). As a result, the uplink data might not be transmitted at one time, and the terminal device 110 has to perform subsequent data transmission which is better to be avoided.

In some examples, if the size of the RRC resume request message with uplink data is 100 bits and the size of PHR is 10 bits (i.e. in total 110 bits). However, if there are only 100 bits allocated by the network device 120. As mentioned above, the priority of the PHR is higher than data. As a result, there will be 10 bits of data which is unable to be transmitted in this uplink grant and needs to be transmitted in the subsequent data transmission phase. However, considering that the PHR is used for subsequent data transmission (e.g., for adjusting the power of uplink transmission of the subsequent data transmission) but has higher priority, resulting in data cannot be transmitted in one time during the initial data transmission phase.

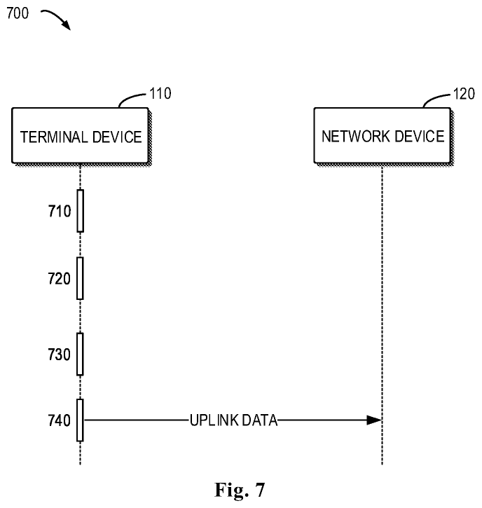

In order to solve the above problem, a solution for SDT is provided. Reference is now made to FIG. 7, which illustrates a signaling flow 700 for a SDT procedure according to some embodiments of the present disclosure. For the purpose of discussion, the signaling flow 700 will be described with reference to FIG. 1A. The signaling flow 700 involves the terminal device 110 and the network device 120 as illustrated in FIG. 1A.

As shown in FIG. 7, the terminal device 110 triggers 710 a PHR. Then, if it is determined that uplink data is to be transmitted in an inactive state, the terminal device 110 determines 720 whether an uplink grant accommodates the uplink data and does not additionally accommodate the PHR. If it is determined that the uplink grant accommodates the uplink data and does not additionally accommodate the PHR, the terminal device 110 allocates 730 a resource to the uplink data. After that, the terminal device 110 transmits 740 the uplink data using the allocated resource.

As such, if PHR is triggered during SDT, if the UL-grant can accommodate all the pending data available for transmission, but is not sufficient to additionally accommodate the accommodate PHR MAC CE plus its header, when performing allocation of resources, the MAC layer shall not select and allocate resource to the logical channel of PHR MAC CE.

Accordingly, if the UL-grant can only accommodate data but not PHR, the UE only transmit data. The SDT procedure can be finished within one transmission.

In some embodiments, if it is determined that the uplink grant does not additionally accommodate the PHR, the terminal device 110 may avoid allocating a resource to a MAC-CE of the PHR. That is, the terminal device 110 will not allocates a resource to the MAC-CE of the PHR. In some embodiments, if the UL-grant can accommodate both data and PHR, the terminal device 110 may transmit both of them at one time.

### Example Implementation of Methods

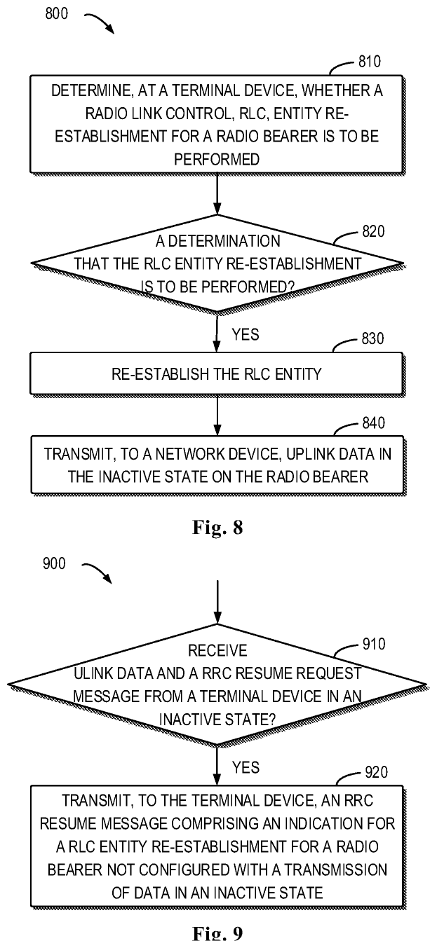

Accordingly, embodiments of the present disclosure provide methods of communication implemented at a terminal device and a network device. These methods will be described below with reference to FIGS. 8 to 13.

FIG. 8 illustrates an example method 800 of communication implemented at a terminal device in accordance with some embodiments of the present disclosure. For example, the method 800 may be performed at the terminal device 110 as shown in FIG. 1A. For the purpose of discussion, in the following, the method 800 will be described with reference to FIG. 1A. It should be understood that the method 800 may include additional blocks not shown and/or may omit some blocks as shown, and the scope of the present disclosure is not limited in this regard.

As shown in FIG. 8, at block 810, the terminal device 110 determines whether a RLC entity re-establishment for a radio bearer is to be performed. The radio bearer is configured with a transmission of data in an inactive state. In some embodiments, determining whether the RLC entity re-establishment is to be performed comprises: if the transmission of the uplink data is to be performed in the inactive state, determining that the RLC entity re-establishment is to be performed; or if a radio resource control, RRC, release message comprising an indication on the RLC entity re-establishment for the radio bearer is received from the network device, determining that the RLC entity re-establishment is to be performed.

At block 820, if it is determined that the RLC entity re-establishment is to be performed, the terminal device 110 re-establishes the RLC entity. After that, the terminal device 110 transmits, to a network device, uplink data in the inactive state on the radio bearer.

In some embodiments, in response to receiving, from the network device, an RRC resume message comprising an indication for a further RLC entity re-establishment for a further radio bearer not configured with the transmission of the data in the inactive state, the terminal device may re-establish the further RLC entity for transmitting data in a connected state.

FIG. 9 illustrates another example method 900 of communication implemented at a network device in accordance with some embodiments of the present disclosure. For example, the method 900 may be performed at a network device 120 as shown in FIG. 1A. For the purpose of discussion, in the following, the method 900 will be described with reference to FIG. 1A. It should be understood that the method 900 may include additional blocks not shown and/or may omit some blocks as shown, and the scope of the present disclosure is not limited in this regard.

As shown in FIG. 9, at block 910, the network device 120 determines whether uplink data and an RRC resume request message are received from a terminal device in an inactive state. If yes, the network device 120 transmits, to the terminal device, an RRC resume message comprising an indication for an RLC entity re-establishment for a radio bearer not configured with a transmission of data in an inactive state.

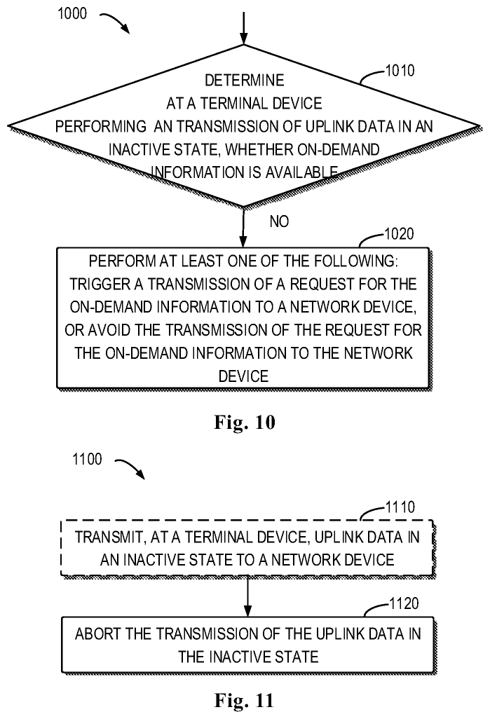

FIG. 10 illustrates another example method 1000 of communication implemented at a terminal device in accordance with some embodiments of the present disclosure. For example, the method 1000 may be performed at the terminal device 110 as shown in FIG. 1A. For the purpose of discussion, in the following, the method 1000 will be described with reference to FIG. 1A. It should be understood that the method 1000 may include additional blocks not shown and/or may omit some blocks as shown, and the scope of the present disclosure is not limited in this regard.

As shown in FIG. 10, at block 1010, the terminal device 110 performing a transmission of uplink data in an inactive state determines whether on-demand information is available. If not, the method 1000 will proceed to block 1020.

At block 1020, if it is determined that the on-demand information is unavailable, the terminal device performs at least one of the following: triggering a transmission of a request for the on-demand information to a network device, or avoiding the transmission of the request for the on-demand information to the network device.

In some embodiments, the on-demand information may comprise at least one of on-demand SI or on-demand PI.

In some embodiments, triggering the transmission of the request may comprise: entering an idle state; and performing an action to request for the on-demand information, the action is performed by at least one of: transmitting a SRB0 message to request for the on-demand information; or initiating a RA procedure.

In some embodiments, triggering the transmission of the request may comprise aborting the transmission of the uplink data in the inactive state; and performing at an action to request for the on-demand information, the action is performed by at least one of: transmitting a SRB0 message to request for the on-demand information; or initiating a RA procedure.

In some embodiments, triggering the transmission of the request may comprise transmitting a SRB1 message or a SRB2 message to request for the on-demand information.

In some embodiments, triggering the transmission of the request may comprise at least one of: transmitting the request after an initial data transmission phase; or transmitting a SRB0 message during the initial data transmission phase.

In some embodiments, phases for the transmission of the uplink data in the inactive state comprise an initial data transmission phase and a subsequent data transmission phase, the method may further comprise: in accordance with a determination that the request is transmitted with a SRB0 message, transmitting the SRB0 message by at least one of: transmitting the SRB0 message together with an RRC resume request message and the transmission of the uplink data in the inactive state in a medium access control protocol data unit, MAC PDU, during the initial data transmission phase; or transmitting the SRB0 message during the subsequent data transmission phase on a CCCH using a C-RNTI or a CS-RNTI.

In some embodiments, the method 1000 may further comprise determining that the request is transmitted with a SRB0 message; and in accordance with a determination that an uplink grant accommodates the uplink data and does not additionally accommodate the SRB0 message, performing at least one of the following: transmitting the request after entering an idle state, or transmitting the request after aborting the transmission of the uplink data in the inactive state.

In some embodiments, determining whether the on-demand information is available comprises at least one of the following: in accordance with a determination that there is no valid version of the on-demand information and the one-demand information is not being broadcasted by the network device, determining the on-demand information is unavailable; and in accordance with a determination that the request for the on-demand information is received at an RRC layer from an upper layer of the terminal device and the one-demand information is not being broadcasted by the network device, determining the on-demand information is unavailable.

FIG. 11 illustrates another example method 1100 of communication implemented at a terminal device in accordance with some embodiments of the present disclosure. For example, the method 1100 may be performed at the terminal device 110 as shown in FIG. 1A. For the purpose of discussion, in the following, the method 1100 will be described with reference to FIG. 1A. It should be understood that the method 1100 may include additional blocks not shown and/or may omit some blocks as shown, and the scope of the present disclosure is not limited in this regard.

As shown in FIG. 11, at block 1110, the terminal device 110 may transmit uplink data in an inactive state to a network device. At block 1120, the terminal device 110 aborts the transmission of the uplink data in the inactive state in response to at least one of the following: receiving a paging message addressing the terminal device from the network device, receiving, at a radio resource control, RRC, layer of the terminal device an abortion of a connection establishment from a non-access stratum layer, an expiration of a first timer related to the transmission of the uplink data in the inactive state, a maximum number of RLC retransmissions has been reached, an initial uplink data transmission fails a predetermined number of times, and an indication being provided from a medium access control, MAC, layer of the terminal device to the RRC layer to cancel the transmission of the uplink data in the inactive state.

In some embodiments, aborting the transmission may comprise stopping the timer related to the transmission of the uplink data in the inactive state.

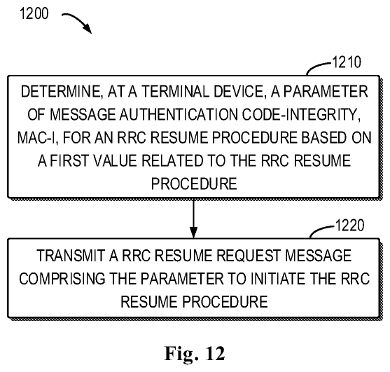

FIG. 12 illustrates an example method 1200 of communication implemented at a terminal device in accordance with some embodiments of the present disclosure. For example, the method 1200 may be performed at the terminal device 110 as shown in FIG. 1A. For the purpose of discussion, in the following, the method 1200 will be described with reference to FIG. 1A. It should be understood that the method 1200 may include additional blocks not shown and/or may omit some blocks as shown, and the scope of the present disclosure is not limited in this regard.

As shown in FIG. 12, at block 1210, the terminal device 110 determines a parameter of MAC-I for a, radio resource control, RRC resume procedure based on a first value related to the RRC resume procedure. Then, at block 1220, the terminal device 110 transmits an RRC resume request message comprising the parameter to initiate the RRC resume procedure. The first value is different from a second value for determining the MAC-I of a further RRC resume procedure.

In some examples, the first value may comprise at least one of: input bits of count for determining the resumeMAC-I, input bits of bearer for determining the resumeMAC-I, and an input bit of direction for determining the resumeMAC-I.

In some embodiments, determining the parameter may include determining the parameter in response to determining at least one of the following: the RRC resume procedure is initiated after aborting a further transmission of a further uplink data in an inactive state, or the RRC resume procedure is for the transmission of the uplink data in the inactive state.

In some embodiments, the first value includes one of more of input bits of count for determining the resumeMAC-I, input bits of bearer for determining the resumeMAC-I, and an input bit of direction for determining the resumeMAC-I. In some embodiments, the predetermined value comprises a sequence of binary ones.

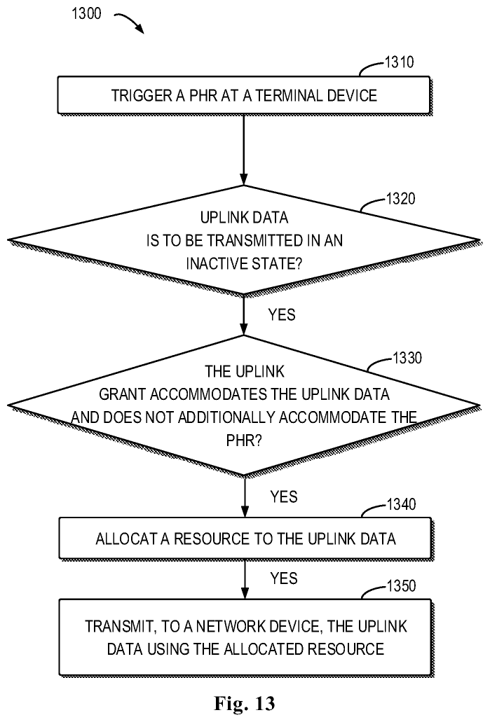

FIG. 13 illustrates an example method 1300 of communication implemented at a terminal device in accordance with some embodiments of the present disclosure. For example, the method 1300 may be performed at the terminal device 110 as shown in FIG. 1A. For the purpose of discussion, in the following, the method 1300 will be described with reference to FIG. 1A. It should be understood that the method 1300 may include additional blocks not shown and/or may omit some blocks as shown, and the scope of the present disclosure is not limited in this regard.

As shown in FIG. 13, at block 1310, the terminal device 110 triggers a PHR. At block 1320, the terminal device 110 determines whether uplink data is to be transmitted in an inactive state. If yes, at block 1330, the terminal device 110 determines whether an uplink grant accommodates the uplink data and does not additionally accommodate the PHR. If yes, then the method 1300 will process to block 1340. At block 1340, the terminal device 110 allocates a resource to the uplink data. After that, at block 1350, the terminal device 110 transmits, to a network device, the uplink data using the allocated resource.

In some embodiments, if it is determined that the uplink grant does not additionally accommodate the PHR, the terminal device 110 may avoid allocating a resource to a medium access control-control element, MAC-CE, of the PHR.

### Example Implementation of Device

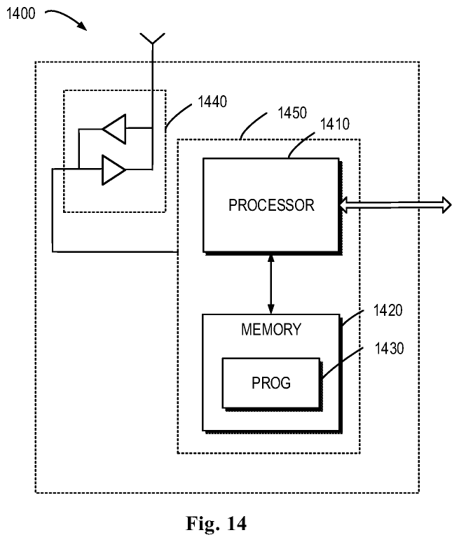

FIG. 14 is a simplified block diagram of a device 1400 that is suitable for implementing embodiments of the present disclosure. The device 1400 can be considered as a further example implementation of the terminal device 110 or the network device 120 as shown in FIG. 1A. Accordingly, the device 1400 can be implemented at or as at least a part of the terminal device 110 or the network device 120.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory; as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a terminal device (e.g., the terminal device 110) comprises circuitry configured to: determine whether a radio link control, RLC, entity re-establishment for a radio bearer is to be performed, the radio bearer being configured with a transmission of data in an inactive state; in accordance with a determination that the RLC entity re-establishment is to be performed, re-establish the RLC entity; and transmit, to a network device, uplink data in the inactive state on the radio bearer.

In some embodiments, the circuitry may be configured to determine whether the RLC entity re-establishment is to be performed by: if the transmission of the uplink data is to be performed in the inactive state, determining that the RLC entity re-establishment is to be performed; or if a radio resource control, RRC, release message comprising an indication on the RLC entity re-establishment for the radio bearer is received from the network device, determining that the RLC entity re-establishment is to be performed.

In some embodiments, the circuitry is further configured to: in response to receive, from the network device, an RRC resume message comprising an indication for a further RLC entity re-establishment for a further radio bearer not configured with the transmission of the data in the inactive state, re-establishing the further RLC entity for transmitting data in a connected state.

In some embodiments, a network device (e.g., the network device 120) comprises circuitry configured to: in response to receiving uplink data and a radio resource control, RRC, resume request message from a terminal device in an inactive state, transmit, to the terminal device, an RRC resume message comprising an indication for a radio link control, RLC, entity re-establishment for a radio bearer not configured with a transmission of data in an inactive state.

In some embodiments, a terminal device comprises circuitry configured to: determine, at the terminal device performing an transmission of uplink data in an inactive state, whether on-demand information is available; and in accordance with a determination that the on-demand information is unavailable, perform at least one of the following: triggering a transmission of a request for the on-demand information to a network device, or avoiding the transmission of the request for the on-demand information to the network device.

In some embodiments, the on-demand information comprises at least one of on-demand system information or on-demand position information.

In some embodiments, the circuitry may be configured to trigger the transmission of the request by: entering an idle state; and performing an action to request for the on-demand information, the action is performed by at least one of: transmitting a SRB0 message to request for the on-demand information; or initiating a random access procedure.

In some embodiments, the circuitry may be configured to trigger the transmission of the request by: aborting the transmission of the uplink data in the inactive state; and performing at an action to request for the on-demand information, the action is performed by at least one of: transmitting a SRB0 message to request for the on-demand information; or initiating a random access procedure.

In some embodiments, the circuitry may be configured to trigger the transmission of the request by: transmitting a signaling radio bear 1, SRB1, message or a signaling radio bear 2, SRB2, message to request for the on-demand information.

In some embodiments, the circuitry may be configured to trigger the transmission of the request by at least one of: transmitting the request after an initial data transmission phase; or transmitting a singling radio bear 0, SRB0, message during the initial data transmission phase.

In some embodiments, phases for the transmission of the uplink data in the inactive state comprise an initial data transmission phase and a subsequent data transmission phase, the circuitry to further configured to: in accordance with a determination that the request is transmitted with a SRB0 message, transmitting the SRB0 message by at least one of: transmitting the SRB0 message together with an RRC resume request message and the transmission of the uplink data in the inactive state in a medium access control protocol data unit, MAC PDU, during the initial data transmission phase; or transmitting the SRB0 message during the subsequent data transmission phase on a common control channel, CCCH, using a C-RNTI or a CS-RNTI.

In some embodiments, the circuitry is further configured to: determine that the request is transmitted with a SRB0 message; and in accordance with a determination that an uplink grant accommodates the uplink data and does not additionally accommodate the SRB0 message, perform at least one of the following: transmitting the request after entering an idle state, or transmitting the request after aborting the transmission of the uplink data in the inactive state.

In some embodiments, the circuitry may be configured to determine whether the on-demand information is available by at least one of the following: in accordance with a determination that there is no valid version of the on-demand information and the one-demand information is not being broadcasted by the network device, determining the on-demand information is unavailable; and in accordance with a determination that the request for the on-demand information is received at an RRC layer from an upper layer of the terminal device and the one-demand information is not being broadcasted by the network device, determining the on-demand information is unavailable.

In some embodiments, a terminal device (e.g., the terminal device 110) comprises circuitry configured to: transmit uplink data in an inactive state to a network device; and abort the transmission of the uplink data in the inactive state in response to at least one of the following: receiving a paging message addressing the terminal device from the network device, receiving, at a radio resource control, RRC, layer of the terminal device an abortion of a connection establishment from a non-access stratum layer, an expiration of a first timer related to the transmission of the uplink data in the inactive state, a maximum number of radio link control, RLC, retransmissions has been reached, an initial uplink data transmission fails a predetermined number of times, and an indication being provided from a medium access control, MAC, layer of the terminal device to the RRC layer to cancel the transmission of the uplink data in the inactive state.

In some embodiments, the circuitry is configured to abort the transmission by stopping the timer related to the transmission of the uplink data in the inactive state.

In some embodiments, a terminal device (e.g., the terminal device 110) comprises circuitry configured to: determine a parameter of MAC-I for an RRC resume procedure based on a first value related to the RRC resume procedure; and transmit an RRC resume request message comprising the parameter to initiate the RRC resume procedure, wherein the first value is different from a second value for determining the MAC-I of a further RRC resume procedure.

In some embodiments, the first value comprises at least one of: input bits of count for determining the resumeMAC-I, input bits of bearer for determining the resumeMAC-I, and an input bit of direction for determining the resumeMAC-I.

In some embodiments, the circuitry is configured to determine the parameter by: determining the parameter in response to determining at least one of the following: the RRC resume procedure is initiated after aborting a further transmission of a further uplink data in an inactive state, or the RRC resume procedure is for the transmission of the uplink data in the inactive state.

In some embodiments, the predetermined value may comprise a sequence of binary ones.

In some embodiments, a terminal device (e.g., the terminal device 110) comprises circuitry configured to: trigger a PHR; in accordance with a determination that uplink data is to be transmitted in an inactive state, determine whether an uplink grant accommodates the uplink data and does not additionally accommodate the PHR; in accordance with a determination that the uplink grant accommodates the uplink data and does not additionally accommodate the PHR, allocate a resource to the uplink data; and transmit, to a network device, the uplink data using the allocated resource.

The circuitry is further configured to in accordance with a determination that the uplink grant does not additionally accommodate the PHR, avoid allocating a resource to a MAC-CE of the PHR.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. A method of a User Equipment (UE), the method comprising:
supporting a Small Data Transmission (SDT) procedure; and
triggering a request for on demand system information to acquire a System Information (SI) message, in a case where:
the UE has not stored a valid version of a System Information Block (SIB),
the SI message is not being broadcasted, and
the SDT procedure is not ongoing.

27. The method according to claim 26, further comprising:
starting a first timer related to the SDT procedure, in a case where the SDT procedure is initiated;
receiving a Radio Resource Control (RRC) Reject message; and
stopping the first timer, upon reception of the RRC Reject message.

28. The method according to claim 27, further comprising:
stopping the first timer, in a case where:
a Radio Link Control (RLC) indicates that a maximum number of retransmissions has been reached, or
a second timer related to the SDT procedure is expired.

29. The method according to claim 26, further comprising:
starting a first timer related to the SDT procedure, in a case where the SDT procedure is initiated; and
stopping the first timer, in a case where:
a Radio Link Control (RLC) indicates that a maximum number of retransmissions has been reached, or
a second timer related to the SDT procedure is expired.

30. A method of a User Equipment (UE), the method comprising:
starting a first timer related to a Small Data Transmission (SDT) procedure, in a case where the SDT procedure is initiated;
receiving a Radio Resource Control (RRC) Reject message; and
stopping the first timer, upon reception of the RRC Reject message.

31. The method according to claim 30, further comprising:
stopping the first timer, in a case where:
a Radio Link Control (RLC) indicates that a maximum number of retransmissions has been reached, or
a second timer related to the SDT procedure is expired.

32. A method of a User Equipment (UE), the method comprising:
starting a first timer related to a Small Data Transmission (SDT) procedure, in a case where the SDT procedure is initiated; and
stopping the first timer, in a case where:
a Radio Link Control (RLC) indicates that a maximum number of retransmissions has been reached, or
a second timer related to the SDT procedure is expired.

33. A User Equipment (UE) comprising:
a memory; and
a processor coupled to the memory, wherein the processor is configured to:
support a Small Data Transmission (SDT) procedure, and
trigger a request for on demand system information to acquire a System Information (SI) message, in a case where:
the UE has not stored a valid version of a System Information Block (SIB),
the SI message is not being broadcasted, and
the SDT procedure is not ongoing.

34. The UE according to claim 33,
wherein the processor is configured to:
start a first timer related to the SDT procedure, in a case where the SDT procedure is initiated,
receive a Radio Resource Control (RRC) Reject message, and
stop the first timer, upon reception of the RRC Reject message.

35. The UE according to claim 34,
wherein the processor is configured to:
stop the first timer, in a case where:
a Radio Link Control (RLC) indicates that a maximum number of retransmissions has been reached, or
a second timer related to the SDT procedure is expired.

36. The UE according to claim 33,
wherein the processor is configured to:
start a first timer related to the SDT procedure, in a case where the SDT procedure is initiated, and
stop the first timer, in a case where:
a Radio Link Control (RLC) indicates that a maximum number of retransmissions has been reached, or
a second timer related to the SDT procedure is expired.

37. A User Equipment (UE) comprising:
a memory; and
a processor coupled to the memory, wherein the processor is configured to:
start a first timer related to a Small Data Transmission (SDT) procedure, in a case where the SDT procedure is initiated,
receive a Radio Resource Control (RRC) Reject message, and
stop the first timer, upon reception of the RRC Reject message.

38. The UE according to claim 37,
wherein the processor is configured to:
stop the first timer, in a case where:
a Radio Link Control (RLC) indicates that a maximum number of retransmissions has been reached, or
a second timer related to the SDT procedure is expired.

39. A User Equipment (UE) comprising:
a memory; and
a processor coupled to the memory, wherein the processor is configured to:
start a first timer related to a Small Data Transmission (SDT) procedure, in a case where the SDT procedure is initiated, and
stop the first timer, in a case where:
a Radio Link Control (RLC) indicates that a maximum number of retransmissions has been reached, or
a second timer related to the SDT procedure is expired.
